(19) United States
(12) Patent Application Publication
(10) Pub. No.: US 2006/0257108 A1
(43) Pub. Date: Nov. 16, 2006

(54) Multimedia reproduction apparatus

(76) Inventor: Seigo Suguta, Osaka (JP)

Correspondence Address: MCDERMOTT WILL & EMERY LLP, 600 13TH STREET, N.W., WASHINGTON, DC, 20005-3096, US

(21) Appl. No.: 11/417,157

(22) Filed: May 4, 2006

(30) Foreign Application Priority Data
May 11, 2005 (JP) 2005-138733

(51) Int. Cl. H04N 7/00

(52) U.S. Cl. 386/95

(57) ABSTRACT

A mutlimedia reproduction apparatus comprises an input processor and a storing section. The input processor receives encoded data, successively separates video data and audio data from the encoded data, extracts time information related to the separated data, thins the extracted time information, and stores the thinned time information into the storing section.

### CROSS REFERENCE TO RELATED APPLICATION

This Non-provisional application claims priority under 35 U.S.C. §119(a) on Patent Application No. 2005-138733 filed in Japan on May 11, 2005, the entire contents of which are hereby incorporated by reference.

### BACKGROUND OF THE INVENTION

1. Field of the Invention

The present invention relates to a mutlimedia reproduction apparatus, and more particularly to, synchronized reproduction of video data and audio data.

2. Description of the Related Art

Conventional mutlimedia reproduction apparatuses separate video data, audio data, and PTS (Presentation Time Stamp) information corresponding to these data, from input encoded data. The separated video data and audio data are categorized and stored into respective buffers. The PTS information is stored into a buffer dedicated thereto. The mutlimedia reproduction apparatus decodes the video data and the audio data and performs synchronized data reproduction based on the PTS information corresponding to these data.

When video data and audio data to be synchronously reproduced are multiplexed at separate positions, sizes of the buffers for the video data and the audio data need to be extended. Due to this, the buffer for storing the PTS information for synchronizing both the data also needs to be extended.

The buffers for the video data and the audio data are provided in an external memory, buffer, and therefore, the sizes thereof can be relatively easily changed. Since the buffer for the PTS information is provided in an internal memory, it is difficult to change the size of the buffer because of a memory size and a memory map of the internal memory. Therefore, the PTS information buffer may overflow, depending on the above-described multiplexed structure. In this case, data required for simultaneous reproduction cannot be stored in the buffer, the video data and the audio data cannot be synchronously reproduced.

Conventionally, there is a known technique of calculating a difference in PTS information and storing the difference in a buffer. Thereby, substantially a large amount of PTS information can be saved without extending the buffer for the PTS information. However, in this case, a circuit structure is complicated due to the calculation of the difference in PTS information.

### SUMMARY OF THE INVENTION

In view of the above-described problems, an object of the present invention is to provide a mutlimedia reproduction apparatus which enables synchronized reproduction of video data and audio data without extending the buffer size of PTS information.

To achieve the object, the present invention provides a mutlimedia reproduction apparatus for reproducing video data and audio data based on time information for synchronizing the video data and the audio data, comprising a storing section for storing the time information, and an input processor for receiving encoded data, successively separating video data and audio data from the encoded data, extracting time information related to the separated data, thinning the extracted time information, and storing the thinned time information into the storing section.

According to this, the input processor successively separates video data and audio data from input encoded data, extracts time information related to the separated data, thins the extracted time information, and stores the thinned time information into the storing section. Thereby, synchronized reproduction of the video data and audio data can be performed without extending the storing section.

Preferably, the input processor is configured to be capable of changing intervals in which the time information is thinned out.

Also, preferably, the thinning-out interval is changed, depending on the type of the encoded data.

Also, preferably, the input processor determines an operating state of the mutlimedia reproduction apparatus, and when the operating state is a startup state, skips thinning of the time information, and when the operating state is a state other than the startup state, performs thinning of the time information.

Thereby, thinning of time information is skipped in a startup process which has a highest possibility that data synchronization is not established, thereby suppressing a time required for a data synchronization process from being elongated.

As described above, according to the present invention, the information amount of the time information is reduced, a buffer for storing the time information is suppressed from overflowing without extending the buffer. Thereby, even when buffers for video data and audio data are extended, synchronized reproduction of the video data and the audio data can be performed without extending the buffer for storing the time information.

### BRIEF DESCRIPTION OF THE DRAWINGS

FIG. 1 is a diagram illustrating a configuration of a mutlimedia reproduction apparatus according to first and second embodiments.

FIG. 2 is a flowchart of a process which is performed by an input processor with respect to PTS information.

### DETAILED DESCRIPTION OF THE PREFFERED EMBODYMENTS

Hereinafter, preferred embodiments of the present invention will be described with reference to the accompanying drawings.

### First Embodiment

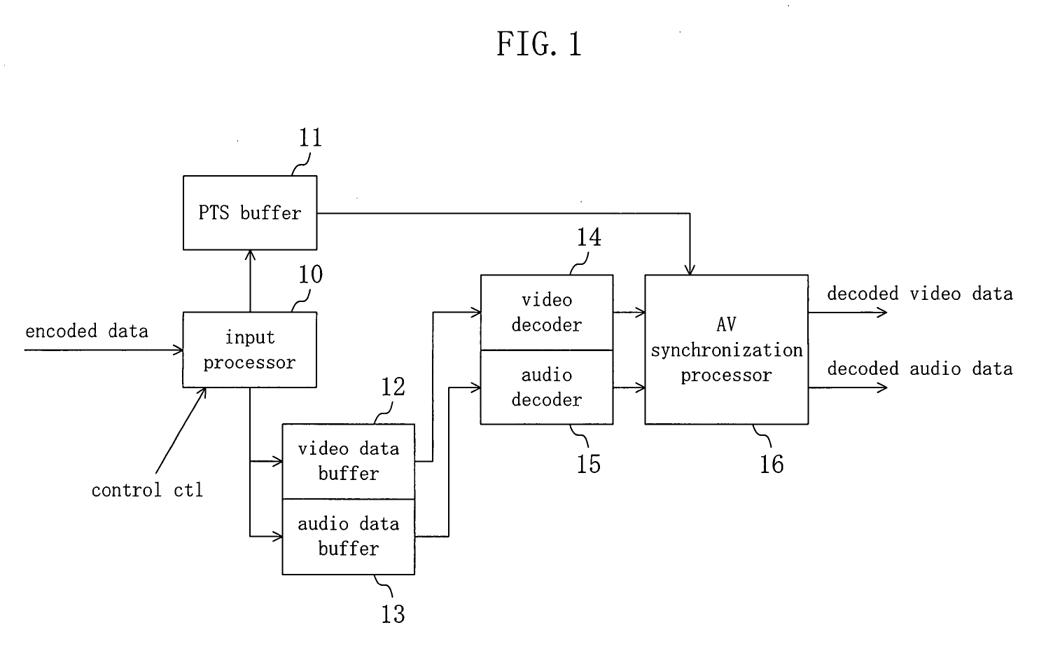

FIG. 1 illustrates a configuration of a mutlimedia reproduction apparatus according to a first embodiment of the present invention. The mutlimedia reproduction apparatus of this embodiment comprises an input processor 10, a PTS buffer 11, a video data buffer 12, an audio data buffer 13, a video decoder 14, an audio decoder 15, and an AV synchronization processor 16.

The input processor 10 categorizes input encoded data into video data and audio data, and outputs the video data and the audio data. Further, the input processor 10 extracts PTS information corresponding to these data from the encoded data.

The PTS buffer 11 stores the PTS information output from the input processor 10.

The video data buffer 12 stores the video data output from the input processor 10.

The audio data buffer 13 stores the audio data output from the input processor 10.

The AV synchronization processor 16 performs synchronized reproduction with respect to data decoded by the video decoder 14 and the audio decoder 15, based on the PTS information stored in the PTS buffer 11.

The input processor 10 thins the PTS information extracted from the encoded data and stores the thinned data into the PTS buffer 11. Note that intervals in which the PTS information is thinned out may be changed using a control ctl internal or external to the mutlimedia reproduction apparatus. For example, in order to secure buffer sizes optimal for reproduction of the video data buffer 12 and the audio data buffer 13, a size of the PTS buffer 11 needs to be changed, depending on the type of the encoded data (e.g., the encoding method, the bit rate, etc.). Therefore, the intervals in which the PTS information is thinned out is changed, depending on the type of the encoded data input to the mutlimedia reproduction apparatus, by the control ctl.

As described above, according to this embodiment, since the PTS information is thinned before being stored, the PTS information corresponding to data stored in the extended video data buffer 12 and audio data buffer 13 is stored without extending the PTS buffer 11. Thereby, synchronized reproduction of video data and audio data can be achieved without extending the PTS buffer 11.

### Second Embodiment

Next, a mutlimedia reproduction apparatus according to a second embodiment of the present invention will be described. Note that the mutlimedia reproduction apparatus of this embodiment has a configuration similar to that of the first embodiment, and the configuration will not be described.

In FIG. 1, when the PTS information is thinned and the resultant data is stored into the PTS buffer 11, a data synchronization process in the AV synchronization processor 16 takes a relatively long time. Therefore, when the above-described adjustment is performed from a startup state which has the highest possibility that data synchronization is not established, it takes a long time to establish data synchronization.

The input processor 10 determines whether an operating state of the mutlimedia reproduction apparatus is in the startup state, or in an ordinary reproduction state after establishment of data synchronization, and based on the determination result, switches the information thinning process.

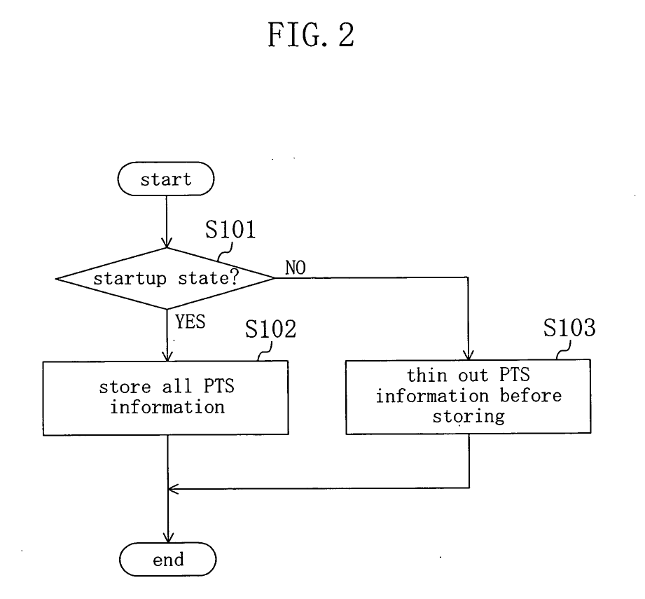

FIG. 2 illustrates a flowchart of a PTS information process performed by the input processor 10. In step S101, it is determined whether or not the operating state of the mutlimedia reproduction apparatus is the startup state. When it is determined that the operating state of the mutlimedia reproduction apparatus is the startup state, all PTS information is stored into the PTS buffer 11 (step S102). On the other hand, when it is determined that the operating state of the mutlimedia reproduction apparatus is the ordinary reproduction state, but not the startup state, PTS information is thinned and stored into the PTS buffer 11 (step S103).

As described above, according to this embodiment, by determining the operating state of the mutlimedia reproduction apparatus using the input processor 10, thinning of PTS information is skipped in the startup state which has the highest possibility that data synchronization is not established, thereby suppressing the time required for the data synchronization process from being elongated.

The mutlimedia reproduction apparatus of the present invention can perform synchronized reproduction of video data and audio data without extending a PTS buffer, and therefore, is useful as an optical disc reproduction apparatus and a digital television set.

What is claimed is:

1. A mutlimedia reproduction apparatus for reproducing video data and audio data based on time information for synchronizing the video data and the audio data, comprising:
a storing section for storing the time information; and
an input processor for receiving encoded data, successively separating video data and audio data from the encoded data, extracting time information related to the separated data, thinning the extracted time information, and storing the thinned time information into the storing section.

2. The mutlimedia reproduction apparatus of claim 1, wherein the input processor is configured to be capable of changing intervals in which the time information is thinned out.

3. The mutlimedia reproduction apparatus of claim 2, wherein the thinning-out interval is changed, depending on the type of the encoded data.

4. The mutlimedia reproduction apparatus of claim 1, wherein the input processor determines an operating state of the mutlimedia reproduction apparatus, and when the operating state is a startup state, skips thinning of the time information, and when the operating state is a state other than the startup state, performs thinning of the time information.
